(19) United States
(12) Patent Application Publication
(10) Pub. No.: US 2019/0349946 A1
(43) Pub. Date: Nov. 14, 2019

(54) Method for Receiver Type Selection

(71) Applicant: Telefonaktiebolaget LM Ericsson (publ), Stockholm (SE)

(72) Inventors: Magnus Åström, Lund (SE); Maomao Chen, Lund (SE); Fredrik Nordström, Lund (SE); Torgny Palenius, Barsebäck (SE)

(21) Appl. No.: 16/088,182

(22) PCT Filed: Mar. 13, 2017
(86) PCT No.: PCT/EP2017/055831

§ 371 Date: Sep. 25, 2018

Related U.S. Application Data
(60) Provisional application No. 62/316,899, filed on Apr. 1, 2016.

(51) Int. Cl. H04W 72/08; H04W 72/12; H04B 1/10

(52) U.S. Cl. CPC H04W 72/082; H04B 1/1027; H04W 72/1231

(57) ABSTRACT

The solution presented herein is directed to communication devices having a plurality of circuits that may be configured into a plurality of different receiver configurations (or classes), where each receiver configuration uses a different technique for processing a received signal. The solution presented herein enables the communication device to select at least one receiver configuration/class for processing received signals. To that end, a performance metric is determined for each receiver configuration in a subset of receiver configurations using at least one of a received signal, a signal strength determined for the corresponding receiver configuration, and an interference level determined for the corresponding receiver configuration. At least one of the receiver configurations in the subset is selected responsive to the determined performance metrics, and in some cases also in response to a scheduled amount of data.

This application claims priority to Provisional U.S. Patent Application 62/316,899 filed 1 Apr. 2016, the disclosure of which is incorporated herein by reference in its entirety.

### TECHNICAL FIELD

The solution presented herein generally relates to wireless communication receivers, and more particularly to the configuration of a wireless communication receiver.

### BACKGROUND

During the evolution of Long Term Evolution (LTE), from the inception in Release 8, via the LTE Advanced features in Release 10, to the present standardization of Release 13, new receivers have repeatedly been added in order to increase performance. Release 8 defined the baseline, Maximum Ratio Combining (MRC) receiver, which is the simplest receiver, and which provides linear minimum mean square error (LMMSE) reception in a spatially white noise environment. In Release 10, the Interference Rejection Combining (IRC) receiver was introduced, providing LMMSE performance in spatially correlated environments, e.g., in the presence of neighboring cell interference. Release 12 brought yet two more new receivers: the single user MIMO (SU-MIMO) receiver and the network assisted interference cancellation and suppression (NAICS) receiver. Multiple Input, Multiple Output (MIMO) refers to a channel's ability to transmit parallel signals from one location to another. By combining the antennas at the transmitter base station (eNB) it is possible to transmit orthogonal, or almost orthogonal, signals. These signals are received at the terminal (UE) and decomposed into their components. The channel rank determines how many parallel streams may be transmitted in order for the UE to correctly receive them with a certain error probability. The rank is tightly coupled with the channel correlation in that a low correlation channel usually has a higher rank and vice versa. The SU-MIMO receiver is therefore a MIMO receiver where the multiple transmitted signals are for a single user, and is either in the form of a maximum likelihood (ML) receiver, or in the form of an iterative codeword interference cancellation (CWIC), which further improves performance in certain situations, e.g., for higher channel correlations. The NAICS receiver was developed to further improve neighboring cell interference cancellation and suppression with the help of additional transmitted information from the network. In Release 13 Cell-Specific Reference Signal (CRS) Interference Mitigation was introduced, which mitigates CRSs from neighboring cells.

In addition to the above, Release 10 introduced Carrier Aggregation (CA), allowing for aggregation of multiple frequency bands. While limited to five carriers in Release 10, CA has been repeatedly increased to now allowing up to 32 carriers (Release 13). Further complicating the receiver design is the introduction of a variable number of antennas, e.g., four RX antennas (4RX), in Release 13. These variable number of antennas may be used either as four antennas in one band (or intraband CA) or pair wise in CA. A similar problem arises for other physically limited hardware resources, e.g., HW accelerators. In LTE, one Fast Fourier Transform (FFT) is performed for each receive antenna, hence limiting the total number of FFTs that are possible to execute.

As a consequence of the above described increase in receiver design space, the possible combinations of different receiver types and available physical hardware resources (antennas, RX chains, HW accelerators) has grown substantially. As a result of this growth, there are too many types of receivers for 3GPP RAN to be able to specify proper functionality for all possible receiver and resource combinations.

### SUMMARY

Communication devices often have a plurality of circuits that may be configured into a plurality of different receiver configurations (or classes), where each receiver configuration uses a different technique for processing a received signal. The solution presented herein enables the communication device to select at least one receiver configuration/class for processing received signals responsive to performance metrics associated with different receiver configurations and a scheduled amount of data to be received. In so doing, the solution presented herein solves problems associated with the large number of different receiver configurations/classes available to the communication device. As used herein, exemplary communication devices include, but are not limited to, mobile telephones, sensors, tablets, personal computers, set-top boxes, cameras, etc.

One exemplary embodiment comprises a method of selecting one or more receiver configurations for a communication device comprising a plurality of circuits configurable into a plurality of different receiver configurations. The method comprises determining a performance metric for each receiver configuration in a subset of the plurality of the different receiver configurations using at least one of a received signal, a signal strength determined for the corresponding receiver configuration, and an interference level determined for the corresponding receiver configuration. The method further comprises determining a scheduled amount of data to be received from the received signal. The method also comprises selecting at least one of the receiver configurations in the subset responsive to the determined performance metrics and the schedule amount of data, and configuring the communication device to use the at least one selected receiver configuration to process signals received by the communication device.

One exemplary embodiment comprises a communication device comprising a reception circuit and one or more processing circuits. The reception circuit comprises a plurality of circuits configurable into a plurality of different receiver configurations. The one or more processing circuits are configured to carry out a method of selecting one or more receiver configurations for the communication device. To that end, the one or more processing circuits are configured to determine a performance metric for each receiver configuration in a subset of the plurality of the different receiver configurations using at least one of a received signal, a signal strength determined for the corresponding receiver configuration, and an interference level determined for the corresponding receiver configuration. The one or more processing circuits are further configured to determine a scheduled amount of data to be received from the received signal. The one or more processing circuits are further configured to select at least one of the receiver configurations in the subset responsive to the determined performance metrics and the schedule amount of data, and to configure the reception circuit to use the at least one selected receiver configuration to process signals received by the communication device. In one exemplary embodiment, the one or more processing circuits comprises a performance circuit configured to determine the performance metrics and a selection circuit configured to make the selection and configure the reception circuit.

One exemplary embodiment comprises a communication device comprising a reception module and one or more processing modules. The reception module comprises a plurality of modules configurable into a plurality of different receiver configurations. The one or more processing modules are configured to carry out a method of selecting one or more receiver configurations for the communication device. To that end, the one or more processing modules are configured to determine a performance metric for each receiver configuration in a subset of the plurality of the different receiver configurations using at least one of a received signal, a signal strength determined for the corresponding receiver configuration, and an interference level determined for the corresponding receiver configuration. The one or more processing modules are further configured to determine a scheduled amount of data to be received from the received signal. The one or more processing modules are further configured to select at least one of the receiver configurations in the subset responsive to the determined performance metrics and the schedule amount of data, and to configure the reception module to use the at least one selected receiver configuration to process signals received by the communication device. In one exemplary embodiment, the one or more processing modules comprises a performance module configured to determine the performance metrics and a selection module configured to make the selection and configure the reception module.

One exemplary embodiment comprises a computer program product stored in a non-transitory computer readable medium for controlling a processor in a communication device comprising a plurality of circuits configurable into a plurality of different receiver configurations. The computer program product comprises software instructions which, when run on the processor, causes the processor to carry out a method of selecting one or more receiver configurations for the communication device. To that end, the software instructions, when run on the processor, cause the processor to determine a performance metric for each receiver configuration in a subset of the plurality of the different receiver configurations using at least one of a received signal, a signal strength determined for the corresponding receiver configuration, and an interference level determined for the corresponding receiver configuration. The software instructions, when run on the processor, further cause the processor to determine a scheduled amount of data to be received from the received signal. The software instructions, when run on the processor, further cause the processor to select at least one of the receiver configurations in the subset responsive to the determined performance metrics and the schedule amount of data, and to configure the reception module to use the at least one selected receiver configuration to process signals received by the communication device.

One exemplary embodiment comprises a method of selecting at least one receiver class for a communication device comprising a plurality of circuits configurable into a plurality of different receiver classes. The method comprises determining a performance metric for each receiver class in a subset of the plurality of different receiver classes using at least one of a received signal, a signal strength determined for the corresponding receiver class, and an interference level determined for the corresponding receiver class. Each of the plurality of different receiver classes comprises a different subset of radio frequency and baseband resources configured to perform a corresponding type of receiver process. The method further comprises selecting at least one of the receiver classes in the subset responsive to the determined performance metrics, and configuring the communication device according to the at least one selected receiver class to process signals received by the communication device according to the corresponding type of receiver process.

One exemplary embodiment comprises a communication device comprising a reception circuit and one or more processing circuits. The reception circuit comprises a plurality of radio frequency and baseband resources configurable into a plurality of different receiver classes. The one or more processing circuits are configured to carry out a method of selecting at least one receiver class for the communication device. To that end, the one or more processing circuits are configured to determine a performance metric for each receiver class in a subset of the plurality of different receiver classes using at least one of a received signal, a signal strength determined for the corresponding receiver class, and an interference level determined for the corresponding receiver class. Each of the plurality of different receiver classes comprises a different subset of radio frequency and baseband resources configured to perform a corresponding type of receiver process. The one or more processing circuits are further configured to select at least one of the receiver classes in the subset responsive to the determined performance metrics, and to configure the reception circuit according to the at least one selected receiver class to process signals received by the communication device according to the corresponding type of receiver process. In one exemplary embodiment, the one or more processing circuits comprise a performance circuit configured to determine the performance metrics and a selection circuit configured to make the selection and configure the reception circuit.

One exemplary embodiment comprises a communication device comprising a reception module and one or more processing modules. The reception module comprises a plurality of radio frequency and baseband resources configurable into a plurality of different receiver classes. The one or more processing modules are configured to carry out a method of selecting at least one receiver class for the communication device. To that end, the one or more processing modules are configured to determine a performance metric for each receiver class in a subset of the plurality of different receiver classes using at least one of a received signal, a signal strength determined for the corresponding receiver class, and an interference level determined for the corresponding receiver class. Each of the plurality of different receiver classes comprises a different subset of radio frequency and baseband resources configured to perform a corresponding type of receiver process. The one or more processing modules are further configured to select at least one of the receiver classes in the subset responsive to the determined performance metrics, and to configure the reception module according to the at least one selected receiver class to process signals received by the communication device according to the corresponding type of receiver process. In one exemplary embodiment, the one or more processing modules comprise a performance module configured to determine the performance metrics and a selection module configured to make the selection and configure the reception circuit.

One exemplary embodiment comprises a computer program product stored in a non-transitory computer readable medium for controlling a processor in a communication device comprising a plurality of radio frequency and baseband resources configurable into a plurality of different receiver classes, the computer program product comprising software instructions which, when run on the processor, causes the processor to carry out a method of selecting at least one receiver class for the communication device. To that end, the software instructions which, when run on the processor, causes the processor to determine a performance metric for each receiver class in a subset of the plurality of different receiver classes using at least one of a received signal, a signal strength determined for the corresponding receiver class, and an interference level determined for the corresponding receiver class. Each of the plurality of different receiver classes comprises a different subset of radio frequency and baseband resources configured to perform a corresponding type of receiver process. The software instructions which, when run on the processor, further causes the processor to select at least one of the receiver classes in the subset responsive to the determined performance metrics, and to configure the reception module according to the at least one selected receiver class to process signals received by the communication device according to the corresponding type of receiver process.

### BRIEF DESCRIPTION OF THE DRAWINGS

FIG. 1 shows exemplary circuits for exemplary resource sets according to the solution presented herein.

FIGS. 2(a)-2(c) show exemplary resource sets according to the solution presented herein.

FIG. 3A shows a method for selecting one or more receiver configurations according to one exemplary embodiment of the solution presented herein.

FIG. 3B shows a method for selecting one or more receiver classes according to one exemplary embodiment of the solution presented herein.

FIG. 4 shows a block diagram for a reception circuit according to one exemplary embodiment of the solution presented herein.

FIG. 5 shows a block diagram for a reception module according to one exemplary embodiment of the solution presented herein.

FIG. 6 compares the performance between three exemplary receiver configurations.

FIGS. 7A-7C show methods for selecting one or more receiver configurations according to exemplary embodiments of the solution presented herein.

FIGS. 8A-8B show methods for selecting one or more receiver configurations according to exemplary embodiments of the solution presented herein.

FIG. 9 shows a block diagram for a reception circuit according to one exemplary embodiment of the solution presented herein.

FIG. 10 shows a block diagram of an exemplary wireless network according to the solution presented herein.

### DETAILED DESCRIPTION

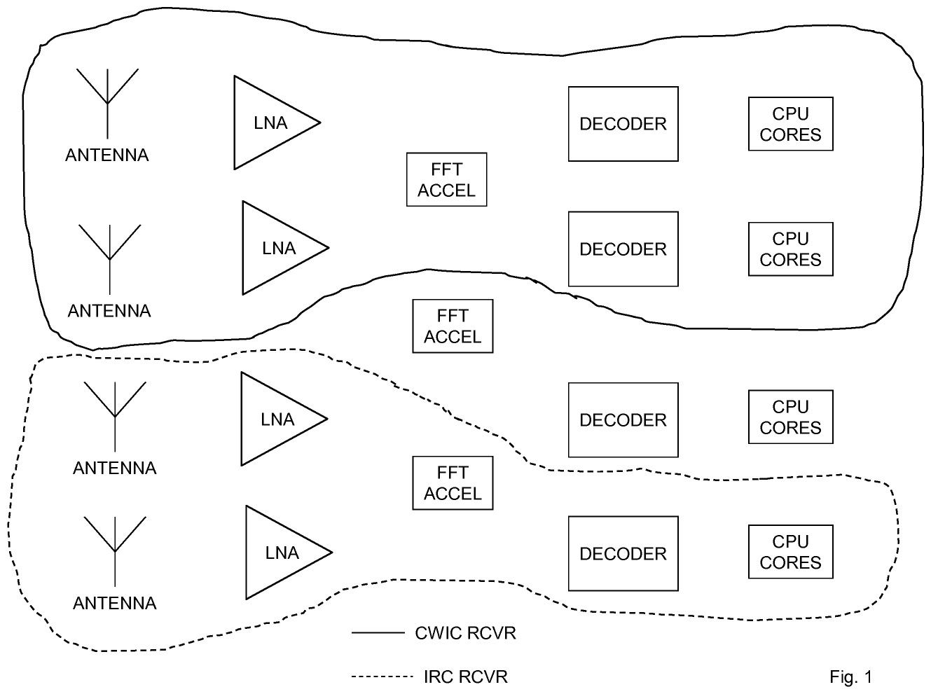

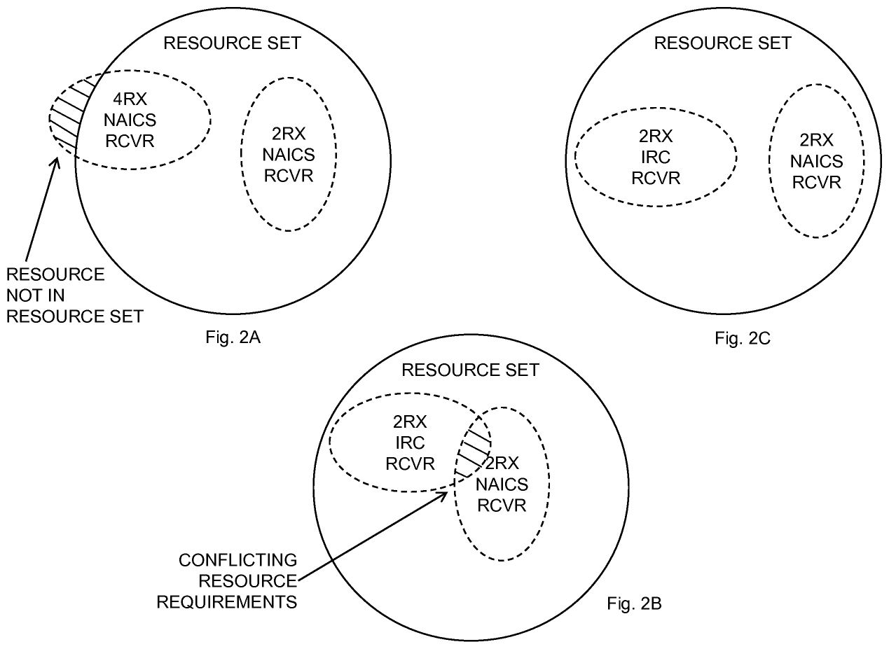

As discussed in further detail below, the solution presented herein enables a communication device to select a desired receiver configuration, which also may be referred to herein as a resource set, receiver class, or a receiver type, to improve the performance of the communication device given the current conditions. As used herein, the phrases “receiver configuration,” “receiver type,” “receiver class,” and “receiver resource set” interchangeably refer to the collection of hardware and software components and capability within the communication device that form a particular receiver, e.g., the NAICS receiver so as to execute the functionality of that particular receiver. For example, one receiver configuration, e.g., the CWIC receiver configuration (or class), may comprise at least two antennas, two amplifiers (LNAs), an FFT, two decoders, and two CPU cores, while another receiver configuration, e.g., the IRC receiver configuration (or class), may comprise at least two antennas, two LNSs, an FFT, a decoder, and a CPU core, as shown in FIG. 1. It will be appreciated that other components not shown in FIG. 1 may be used for a particular receiver configuration, e.g., two filters, two variable amplifiers (VGAs), two analog-to-digital converters (ADCs) for either or both of the CWIC and IRC receiver configurations. Thus FIG. 1 simply shows examples of those component blocks that are specific to two exemplary receiver configurations, e.g., the CWIC and IRC receiver configurations. Some receiver configurations will use independent hardware and processing components, as shown in FIGS. 2A and 2C, which in some embodiments, may allow for the selection and use of multiple receiver configurations or classes. In FIG. 2A, for example, the 4 RX NAICS receiver requires resources that are not in the resource set, making it unfeasible/unavailable for selection. In FIG. 2C, however, the resources for both the 2 RX IRC and 2RX NAICS receivers are in the receiver set and do not conflict, making them both available for selection. In other embodiments, some receiver configurations will have overlapping hardware and/or processing components, e.g., as shown in FIG. 2B, which may prevent the communication device from using both receiver configurations (e.g., the 2 RX IRC and the 2 RX NAICS receivers) at the same time. Exemplary receiver configurations include, but are not limited to a maximum ratio combining receiver configuration, a two antenna interference rejection combining receiver configuration, a four antenna interference rejection combining receiver configuration, a single user multiple input, multiple output receiver configuration, a two antenna network assisted interference cancellation and suppression receiver configuration, a four antenna network assisted interference cancellation and suppression receiver configuration, and a common reference signal interference cancellation receiver configuration. It will also be appreciated that, as used herein, the receiver resource set represents the subset of resources in the communication device used to implement a particular receiver. For example, the solution presented herein may be described in terms of one or more receiver classes, where each receiver class comprises a different subset of radio frequency and baseband resources, e.g., as shown in FIG. 1 and/or FIGS. 2A-2C, configured to perform a corresponding type of receiver process.

Current state-of-the-art communication devices comprise several different receiver types that are suitable for different conditions. A low-complexity, linear MRC receiver type is sufficient in an environment where no interference is present, whereas a linear IRC receiver type is able to cancel out interference making it highly suitable in an interference rich environment. More advanced, nonlinear receivers such as CWIC and ML receiver types are usually better than the linear receivers, but they are also much more computationally demanding, and therefore have a higher level of complexity. Within the non-linear receivers, the complexity of the CWIC is linear with the number of code words, whereas the complexity of the iterative ML receiver type varies with the modulation order M to the power of the transmission rank R according to O(M^{R}). In order to reduce complexity, simplified versions of the iterative ML receiver type have been derived, e.g., the sphere decoder, in which complexity instead depends on the channel and the noise. For higher ranks, one receiver type may not be possible to use due to its computational complexity being too high. The solution presented herein considers at least some of these characterizations of each receiver type when determining the optimal receiver type from a subset of receiver types.

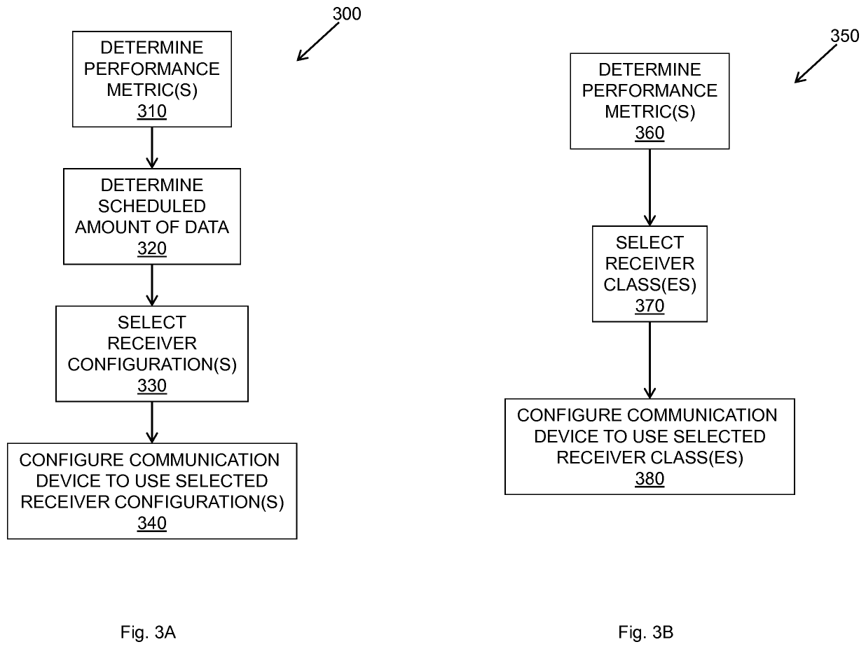

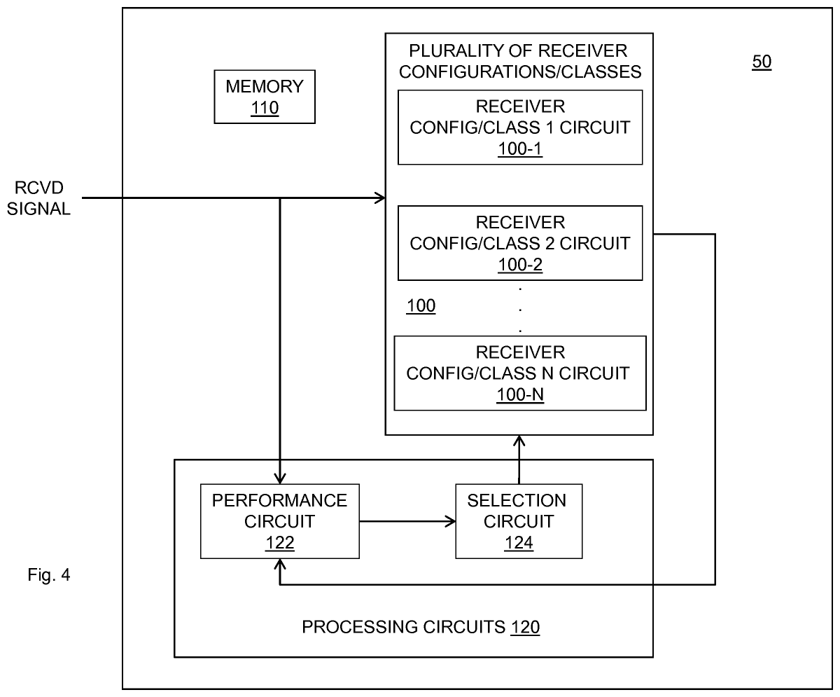

As noted above, the solution presented herein provides a selection process for selecting one or more of a plurality of receiver configurations/classes for use by the communication device to process signals received by the communication device. Before describing the details of this solution, the solution is described more generally with the aid of FIGS. 3-5.

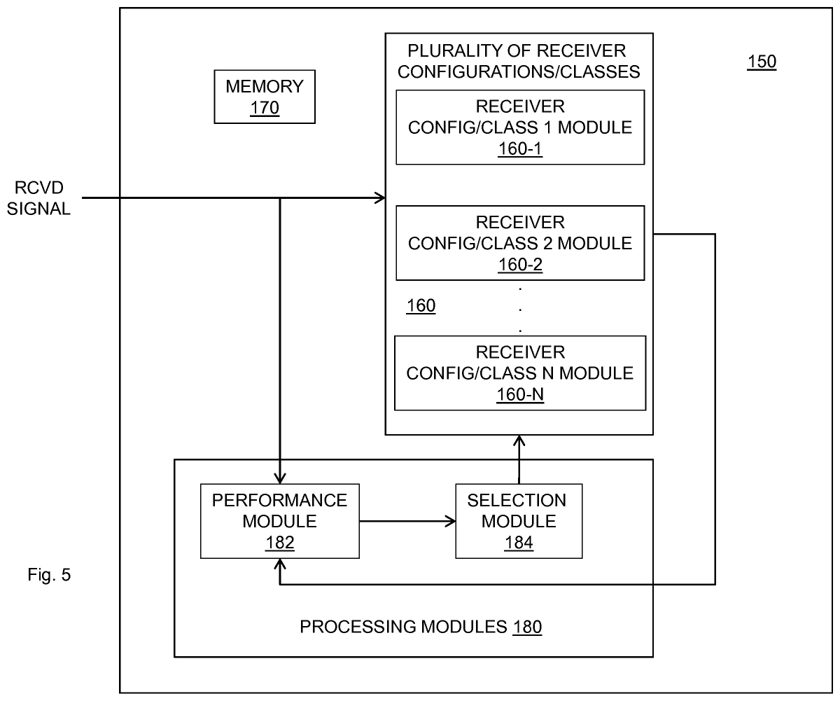

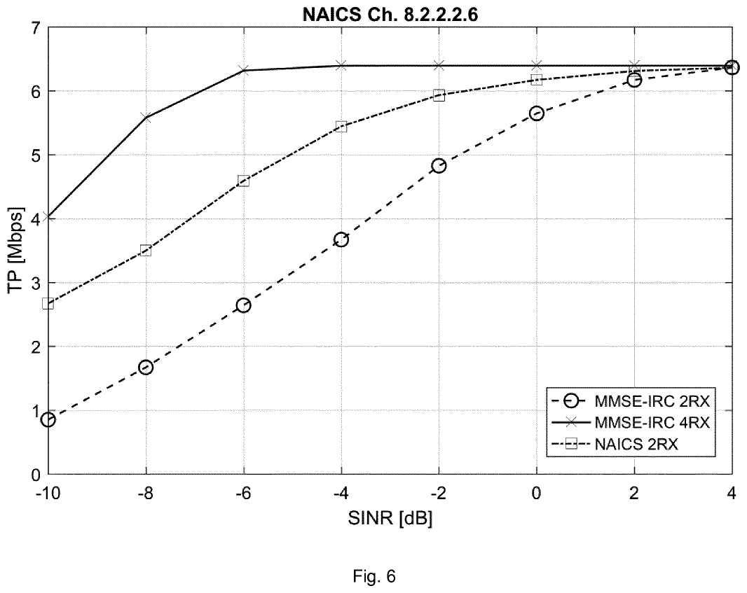

FIG. 3A shows an exemplary method 300 for selecting one or more receiver configurations for a communication device comprising a plurality of circuits configurable into a plurality of different receiver configurations (see FIGS. 4 and 5). The plurality of circuits includes all elements necessary for implementing the various receiver configurations, e.g., antennas, amplifiers, FFTs, decoders, processors, CPU cores, mixers, etc. Method 300 comprises determining a performance metric for each receiver configuration in a subset of the plurality of the different receiver configurations using at least one of a received signal, a signal strength determined for the corresponding receiver configuration, and an interference level determined for the corresponding receiver configuration (block 310). The subset may comprise all possible receiver configurations, or may comprise some number of receiver configurations less than all possible receiver configurations. In the latter case, the receiver configurations of the subset may be selected for the subset using any desired information pertinent to the communication device, the operation of the receiver, and/or the current environment of the communication device. For example, the subset may be chosen in light of hardware, software, and/or processing resources currently available to the communication device. It will be appreciated that other information may also or alternatively be used to select the subset, e.g., desired complexity, channel conditions, channel rank, etc. The method 300 further comprises determining a scheduled amount of data to be received from the received signals (block 320). The method 300 also comprises selecting at least one of the receiver configurations in the subset responsive to the determined performance metrics and the scheduled amount of data (block 330), and configuring the communication device to use the selected receiver configuration(s) to process signals received by the communication device (block 340). In some embodiments, in addition to the performance metrics and the scheduled amount of data, the selection may be responsive to a complexity of each receiver configuration and/or one or more resources available to the communication device.

FIG. 3B shows an exemplary method 350 for selecting one or more receiver classes for a communication device comprising a plurality of circuits configurable into a plurality of different receiver classes (see FIGS. 4 and 5). The plurality of circuits includes all radio frequency and based band resource elements necessary for implementing the various receiver classes, e.g., antennas, amplifiers, FFTs, decoders, processors, CPU cores, mixers, etc. Method 350 comprises determining a performance metric for each receiver class in a subset of the plurality of the different receiver classes using at least one of a received signal, a signal strength determined for the corresponding receiver class, and an interference level determined for the corresponding receiver class (block 360). The subset of the plurality of different receiver classes may comprise all possible receiver classes, or may comprise some number of receiver classes less than all possible receiver classes. In the latter case, the receiver classes of the subset may be selected for the subset using any desired information pertinent to the communication device, the operation of the receiver, and/or the current environment of the communication device. For example, the subset may be chosen in light of hardware, software, and/or processing resources currently available to the communication device. It will be appreciated that other information may also or alternatively be used to select the subset, e.g., desired complexity, channel conditions, channel rank, etc. The method 350 further comprises selecting at least one of the receiver classes in the subset responsive to the determined performance metrics (block 370), and configuring the communication device to use the selected receiver class(es) to process signals received by the communication device according to the corresponding type of receiver process (block 380). In some embodiments, in addition to the performance metrics, the selection may be responsive to a complexity of each receiver class and/or one or more resources available to the communication device.

FIG. 4 shows a block diagram for an exemplary communication device 50 configured to implement the method 300 of FIG. 3A and/or the method 350 of FIG. 3B. Communication device 50 comprises a reception circuit 100 comprising plurality of receiver configurations 100-1, 100-2, . . . 100-N, a memory 110, and one or more processing circuits 120, which may comprise a performance circuit 122, and a selection circuit 124. Each of the receiver configurations 100-1, 100-2 . . . 100-N represents one set of resources available to perform reception operations associated with one receiver type (e.g., as shown in FIG. 1), which may also be understood to be the hardware and processing components required to implement each receiver configuration. As shown in FIGS. 2A-2C, for example, different receiver configurations may comprise separate processing resources (e.g., FIGS. 2A and 2C), or may share processing resources (e.g., FIG. 2B). Memory 110 comprises any known memory, and may be used to store data and/or instructions necessary for the operation of the communication device 50. The processing circuits are configured to execute the determination, selection, and configuration steps of the methods of FIG. 3A or 3B. For example, performance circuit 122 is configured to determine a performance metric for each receiver configuration in a subset of the plurality of different receiver configurations 100 using at least one of a received signal, a signal strength determined for the corresponding receiver configuration, and an interference level determined for the corresponding receiver configuration. For example, the performance circuit 122 may determine a signal and interference level for each receiver configuration in the subset, and then determine a throughput for each receiver configuration in the subset using the determined signal and interference levels. In another example, the performance circuit 122 may determine a channel rank responsive to the received signal, and determine the performance metric for each receiver configuration in the subset using the channel rank. Other exemplary performance metrics include, but are not limited to, a power consumption of the corresponding receiver configuration, a latency associated with the corresponding receiver configuration, a channel capacity, the signal level of the corresponding receiver configuration, an interference level of the corresponding receiver configuration, and/or a signal-to-interference plus noise ratio of the corresponding receiver configuration.

The selection circuit 124 is configured to select at least one of the receiver configurations 100-1, 100-2 . . . 100-N in the subset responsive to the determined performance metrics. For example, the selection circuit 124 may select the receiver configuration 100-1, 100-2 . . . 100-N having the best performance metric. It will also be appreciated that in some embodiments, where the subset includes multiple independent receiver configurations, the selection circuit 124 may select two or more receiver configurations responsive to the determined performance metrics. In still other embodiments, the selection circuit 124 may consider both the performance metrics and a scheduled amount of data when making the selection. In any event, the reception circuit 100 uses the selected receiver configuration(s) to process signals received by the communication device 50. While the solution of FIG. 4 is described in terms of separate performance and selection circuits, it will be appreciated that the determination, selection, and configuration steps may be executed by one or more processing circuits configured to execute these steps.

It will be appreciated that other devices may implement the method 300 of FIG. 3A and/or the method 350 of FIG. 3B. For example, the communication device 150 shown in FIG. 5 may use a receiver module 160 comprising a plurality of receiver configuration modules 160-1, 160-2, . . . , 160-N, a memory module 170, and one or more processing modules 180, which may comprise a performance module 182 and selection module 184 to implement method 300 and/or method 350. Those of skill in the art will also readily recognize that the methods 300/350 described herein may be implemented as stored computer program instructions for execution by one or more computing devices, such as microprocessors, Digital Signal Processors (DSPs), FPGAs, ASICs, or other data processing circuits. The stored program instructions may be stored on machine-readable media, such as electrical, magnetic, or optical memory devices. The memory devices may include ROM and/or RAM modules, flash memory, hard disk drives, magnetic disc drives, optical disc drives and other storage media known in the art. For example, method 300 and/or method 350 may be implemented using a processor comprising software instructions that when run on the processor cause the processor to execute the method 300 of FIG. 3A or the method 350 of FIG. 3B. While the solution of FIG. 5 is described in terms of separate performance and selection modules, it will be appreciated that the determination, selection, and configuration steps may be executed by one or more processing modules configured to execute these steps.

As discussed above, there are many different receiver types, including but not limited to, MRC receiver types, Interference Rejection Combining (IRC) receiver types, SU-MIMO receiver types, including CWIC and iterative ML receiver types. The following provides a brief discussion of additional details regarding these receiver types.

Linear MRC receivers optimize the minimum mean square error (MMSE) assuming a channel model:

y=Hx+w, (1)

where x represents the transmitted signal vector, H represents the channel matrix, w represents additive Gaussian noise, and y represents the received signal. An optimal MRC receiver type may then be expressed as:

\hat{x}=(H^{H}H+R_{w})⁻¹H^{H}y, (2)

where, in the case of the MRC, spatially white noise may be represented by:

$$R = [ \begin{matrix}{σ}_{0}^{2} & … & 0 \\ ⋮ & ⋱ & ⋮ \\ 0 & … & {σ}_{N - 1}^{2}\end{matrix} ] , \qquad ( 3 )$$

whereas the IRC receiver type assumes spatially colored noise, e.g.:

$$R = [ \begin{matrix}{σ}_{0 , 0}^{2} & … & {σ}_{0 , N - 1}^{2} \\ ⋮ & ⋱ & ⋮ \\ {σ}_{N - 1 , 0}^{2} & … & {σ}_{N - 1 , N - 1}^{2}\end{matrix} ] \qquad ( 4 )$$

The main complexity component of the MMSE receiver type is the matrix inversion.

The CWIC receiver type is based on a linear receiver in which a decoded code word is recoded and remodulated and then subtracted from the received signal such that inter-code word interference is eliminated. Because the CWIC is operating on a code word basis, its complexity is independent of rank above rank 2, because LTE uses two code words except for rank one. However, because it is an iterative decoder, its complexity is approximately three times that of the MMSE receiver (assuming initial decoding and one iteration per CW).

The iterative ML decoder of the ML receiver type is based on ML detection by maximizing the á posteriori probability:

P(x|y)∝P(y|x)·P(x) (5)

of the channel model in Equation (1). By performing the optimization iteratively, soft input values of P(x) improve performance between iterations.

The performance assessment differs from receiver to receiver. However, one assessment algorithm for one exemplary embodiment may be given as follows:
Estimate the receiver antenna interference statistics on a resource element (RE) basis. Often this statistic is approximated by using interference statistics from neighboring cell (NC) pilots, e.g., Cell-Specific Reference Signal (CRS) or Demodulation Reference Signal (DMRS), and uses the same value over a full resource block (RB). However, in other cases the statistic is evaluated on a RE basis.
Assess the amount of interference suppression that may be possible with the specific receiver type. Typically, an MRC receiver type is unable to provide interference suppression, whereas more complex IRC and NAICS receiver types are better at providing interference suppression.
Estimate the receiver antenna signal strength, similar to how interference was estimated, typically from serving cell (SC) pilots.
Based on the above three pieces of data, it is possible to compute the signal-to-interference and noise ratio (SINR) in which also the amount of interference suppression is accounted for. From there, a channel capacity value may be derived and mapped to throughput.

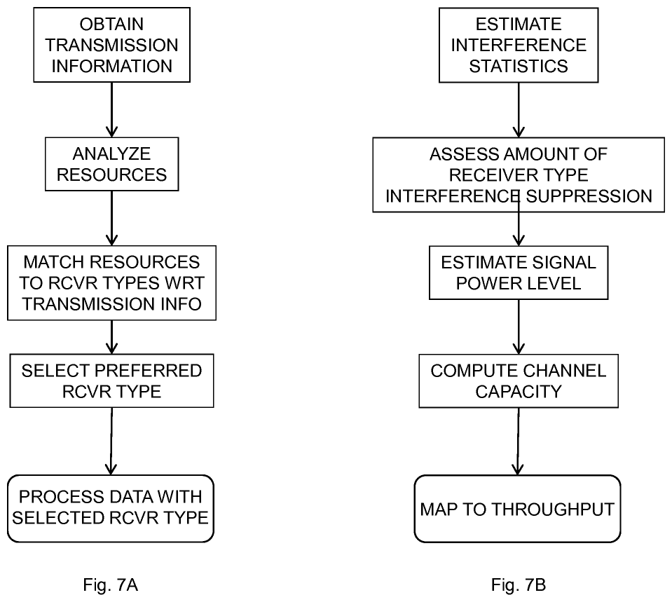

Increasing the receiver design space to also include the dimension of number of antennas, the previously relatively straightforward choice of one receiver type becomes significantly more complicated. Because not all receiver types are standardized with all antenna setups, it is no longer evident which receiver type is preferred, and which ones are not. For example, one receiver type may be run with 2RX whereas another may be run with 4RX. As an example of this, FIG. 6 shows a throughput performance comparison between a 2RX IRC, 4RX IRC, and a 2RX NAICS receiver type for a specific transmission environment. It is obvious that a 4RX IRC receiver type is preferred over a 2RX NAICS receiver type, and, correspondingly, the 2RX NAICS receiver type is preferred over the 2RX IRC receiver type.

A simple decision for a fixed number of receive antennas becomes much more complicated because several constraints need to be considered. For example, in the example above, it is likely that a 4RX NAICS receiver type would perform even better than the 4RX IRC receiver type. However, the 4RX NAICS receiver type may be unfeasible from a computational complexity perspective, since such a receiver type would consume too many CPU resources. For this reason, the solution presented herein considers the present environment when selecting a receiver type, as well as possibly the number of antennas and/or the band, in order to optimize performance.

The solution presented herein provides a method in a device that is implemented according to a specified standard in which multiple receivers are defined, that, upon being scheduled, analyzes the present environment, and based on that analysis makes a decision about which receiver type(s) and corresponding resource combination(s) that is/are preferred for the present conditions, and then uses the selected receiver type(s) for data reception.

The advantage of the solution presented herein is that a UE, capable of receiving with a multitude of receiver types that are defined in a standard, will select preferred receiver type(s), according to a certain performance metric, for data reception. Thus, performance is optimized, e.g., in terms of throughput, latency, or power consumption/preservation, or a combination thereof.

The solution presented herein is a method in a wireless receiver, which may comprise a modem or transceiver, supporting a multitude of standardized receiver types, where each receiver type requires its own amount of resources. In one embodiment, the method comprises:
Obtaining transmission information in order to know what transmissions can be expected, including but not limited to the scheduled amount of data. In one embodiment, transmission information may be channel properties, e.g., channel rank, SNR level, and/or interference properties, e.g., interference levels, and/or network properties, e.g., CRS scheduling (colliding vs non-colliding) or network synchronization. In another embodiment, transmission properties may include transmission parameters included in the Master Information Block (MIB) or System Information Block (SIB), or corresponding information blocks, comprising information like channel bandwidth and number of codewords, or control channel information specifying the scheduled amount of data, allocated bandwidth, and/or resource blocks together with the transmission properties transmission rank and Modulation and Coding Scheme (MCS).
Analyzing the available receiver resources, in terms of CPU clock cycles, power consumption, and/or number of required HW blocks. CPU clock cycles may in turn comprise assessing the CPU frequency, latency requirements, and/or node timing advanced requirements. Power consumption assessment may include the power consumption of the different receiver types and/or the remaining battery power, in order to go into a low power mode should that be significantly extend longevity. The required HW blocks for a certain receiver may include analogue or RF blocks, e.g., antennas, LNAs, mixers, ADCs, etc., and/or it may include baseband processing blocks like FFT, Turbo decoders, or combiners.
Matching resources to the different receiver types considering the transmission information. A transmission with a higher rank, MCS or a larger bandwidth will be more demanding than a transmission with a lower rank, MCS or a smaller bandwidth. One embodiment of this is to not considering receiver types requiring more than the available resources. Another embodiment modifies the capabilities of the receiver type, e.g., by reducing rank, MCS, bandwidth, e.g., number of Component Carriers (CC) in Carrier Aggregation (CA), or the number of iterations that an iterative receiver, e.g., CWIC, may be allowed to perform. One embodiment considers splitting a receiver type into two or more types (e.g., modifying a receiver configuration relative to the original configuration), provided resources does not allow for the full use of the receiver type, and there are more than one possible reduction possibilities to the receiver type. For example, considering the case of a preferred 4RX IRC receiver type with CA capabilities for which case the number of CPU cycles may not be sufficient. In that case the receiver type may be split into a 2RX IRC receiver type when scheduled with CA, or a 4RX IRC receiver type when not scheduled with CA.
Selecting a preferred receiver type according to a performance metric. Different receiver types will perform differently, in the performance space. Examples of different performance quantities are throughput or related quantities, e.g., information, latency, and/or power. Also combinations of the said quantities may be used.
Processing data using the selected receiver type(s), which in one embodiment may involve receiving (e.g., demodulating and decoding) data whereas in another embodiment this may include assessing Channel State Information (CSI) and reporting it back to the transmitting node.

Typical receiver types that are considered in this solution are MRC, IRC, SU-MIMO (R-ML or CWIC) NAICS or CRS-IC receiver type or similar receiver type based on cancellation of known signals. A receiver type can also be defined using different resources, e.g., an IRC with 2RX and IRC with 4RX, where e.g., the first may be used for CA and the second can be used for single carrier. Further, in some embodiments, the available receiver types may comprise one or more modified receiver types, where each modified receiver type has modified hardware and/or software relative to its original configuration. For example, a receiver type may be modified to include fewer antennas than its original configuration. The modified receiver types may comprise one or more circuits from the original configuration (e.g., original receiver type) that have been modified to define at least one of a rank, a modulation and coding scheme, a bandwidth, a number of component carriers, and a number of receiver iterations, e.g., responsive to the resources available to the communication device. In any event, each receiver type has its own performance characteristics in terms of both resource requirements and receiver performance, e.g., throughput, for given channel conditions and network capabilities.

The solution presented herein is a method in a wireless receiver that is able to receive data using any one receiver type within a subset of receiver types. Each receiver type is furthermore defined for utilizing a defined set of resources, e.g., a number of receiver antennas, analog receiver blocks, HW accelerators, or CPU cycles. The method comprises receiving scheduled allocated data, whereupon the transmission environment (e.g., wireless channel) is analyzed for each type of receiver. The analysis may, in one embodiment, be based on an aggregated information measure derived from an estimated channel rank and rank information. Having made the analysis, a preferred receiver type is selected. In one exemplary embodiment, the preferred receiver type is the one maximizing data throughput. As such, the selection of the solution presented herein may be responsive to the scheduled amount of data. Finally, having made the decision, the selected receiver type starts receiving and processing data.

In one embodiment, instead of using throughput as metric, aggregated information may be used. Because different receiver types may imply different control signaling, in turn resulting in different data REs, the two measures may not always be the same. Other performance metrics may include latency or power consumption. In further embodiments, the receiver complexity may also be considered, e.g., by requiring a performance metric increase to exceed a complexity metric increase, e.g., if a first receiver type, R₁, has a performance metric P₁, and a complexity C₁, then, in order for a receiver type R₂ having a performance metric P₂ and a complexity C₂ to be selected:

$${C}_{2} < f ( \frac{{P}_{2}}{{P}_{1}} , {C}_{1} ) \qquad ( 6 )$$

In other words, the complexity C₂ of R₂ should not exceed a function of the performance ratio of P₂ and P₁ and the complexity C₁ of R₁, where f (a,b), e.g., may be given by:

f(a,b)=ab (7)

In a further embodiment, the remaining power may also be considered when making such a weighing, e.g., by always selecting the simplest receiver when only a fraction, c, of the total battery power remains, as given by:

$$f ( a , b ) = \{ \begin{matrix}ab , c \geq \frac{1}{10} \\ ∞ , c < \frac{1}{10}\end{matrix} \qquad ( 8 )$$

Hence, in order for another receiver to be selected, the complexity should be increasingly lower compared to the first receiver.

In yet another embodiment, the number of RX antennas is included in the consideration such that receiver types that are only defined for a limited number of receiver antennas are only assessed with this limited number.

Some embodiments deal with preferred combinations of sparse HW resources, e.g., receiver antennas or HW accelerators. For example CA may require antennas (or receiver chains) to be separated with respect to component carrier (CC) bands, whereas a single band receiver typically also improves performance with the number of antennas. Similarly, certain combinations of receiver types may not be possible due to excess HW accelerator utilization.

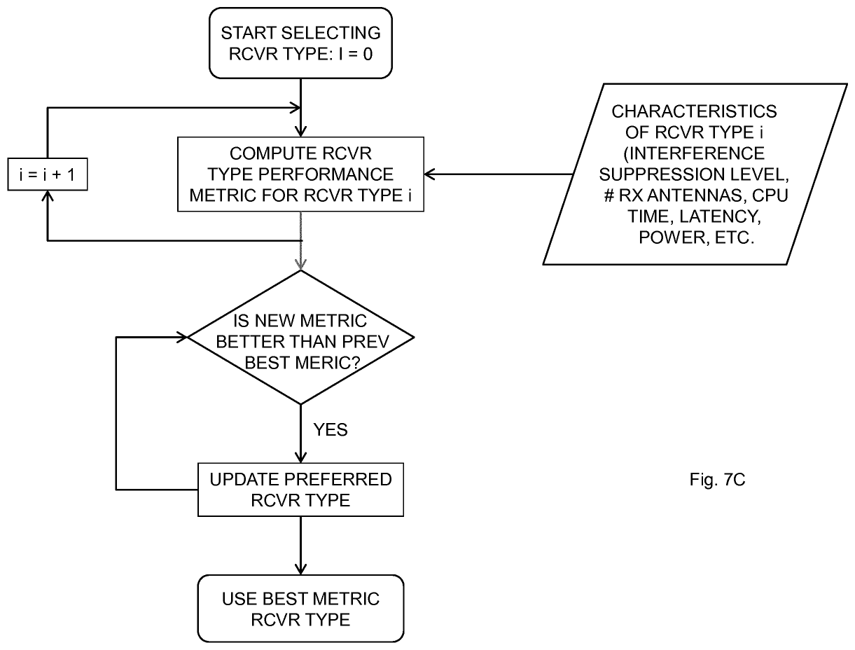

FIG. 7 shows exemplary flowcharts describing various embodiments of the solution. FIG. 7A shows a flowchart of the general solution. FIG. 7B shows one implementation of computing a throughput metric, and FIG. 7C shows an iterative process on how to derive the best receiver type, according to a certain metric.

More particularly, FIG. 7A describes a method in a wireless communication device, comprising a multitude of standardized receiver types (e.g., receiver configurations), each of which requiring its own amount of hardware and software resources of the communication device. In this example, the illustrated method includes obtaining transmission information, analyzing available resources, matching resources to the different receiver types considering the transmission information, selecting at least one preferred receiver type according to performance metric(s), and processing data using the selected receiver type(s). Transmission information may include, but is not limited to, channel properties (e.g., channel rank, SNR, interference properties, e.g., power, colliding CRSs, network synchronization (synchronized or unsynchronized)), transmission parameters (e.g., MIB or SIB information, e.g., channel bandwidth and/or number of codewords, or control channel information, e.g., allocated bandwidth or resource blocks, transmission rank, and/or modulation and coding scheme). In some embodiments, the analysis is based on CPU clock cycles (including CPU frequency, latency requirements, timing advanced, etc.), power consumption (e.g., remaining battery power, receiver type power consumption, etc.), HW accelerators (e.g., FFTs, Turbo decoders, combiners, etc.), and/or analog/RF blocks (e.g., antennas, LNAs, mixers, ADCs, etc.). It will be appreciated that, for example, that when the analysis is based on CPU clock cycles, the amount of scheduled data may be considered in the analysis because the communication device wants to finish before the next subframe starts. The analysis may also take into account a complexity metric of the algorithms and corresponding capabilities of the receiver type. Further, the analysis may consider the relative performance gains in relation to increased complexity costs. In one embodiment, the matching of the resources may be done such that a receiver type may not use more resources than is available. In another embodiment, the matching of the resources may be done such that a receiver type's capabilities are modified with respect to the available resources, e.g., with respect to rank, MCS, number of iterations, etc. The performance metric may include, but is not limited to, throughput of information, latency, power, etc. The processing of data using the selected receiver type may include, but is not limited to, reporting channel state information, demodulation and decoding of data, etc. The receiver types comprise at least one of the following, and may comprise combinations of the following receiver types:
MRC receiver
IRC receiver
SU-MIMO receiver (R-ML or CWIC) or similar inter-layer mitigation
NAICS receiver
CRS-IC receiver or similar receiver based on cancellation of known signals
   The selection may also consider the number of RX antennas that are defined for the receiver type.

Some embodiments of the solution presented herein may consider the channel rank, MCSs, or both the channel rank and MCSs. In order to optimally utilize spectrum, the communication devices feedback channel state information (CSI) that the eNB base station subsequently uses. CSI information typically includes a channel quality indicator (CQI) representing certain setups of the modulation and coding scheme (MCS), a precoding matrix indicator (PMI) representing the preferred precoding matrix, and a rank indicator (RI) representing the number of spatial streams that the UE can resolve. CQI and PMI are conditioned on a certain RI

In one embodiment, the selection of the receiver type is based on properties of the received signal, e.g., the estimated channel rank and/or modulation order. This is done by receiving a (pilot) signal, computing the rank and/or corresponding modulation orders of the channel by help of said signal, analyzing the suitable receiver types for the computed rank and/or modulation orders, selecting at least one appropriate receiver type, and using the selected receiver type(s) to process signals received by the communication device.

Higher complexity receiver types, typically iterative receivers, may provide substantial gains over simpler linear receivers. However, due to their higher complexity, restrictions may apply to which transmission setups they are possible to use. Typically, more layers and higher modulation order increases complexity significantly, up to the point when the receiver type is unable to finish within its allocated computational resources. The solution presented herein is a method for handling such problems in that it discriminates different receiver types depending on their complexity for the given transmission setup, and then, based on the analysis, decides which of the receiver types that is the most suitable to use. The chosen receiver type is then used, e.g., for receiving data or computing CSI information.

The solution presented herein is a method for receiver type selection based on the rank and/or modulation order of a channel over which the received signal has been transmitted. In one embodiment, the solution presented herein comprises receiving a signal that has been transmitted by a remote transmitter, e.g., an eNB, and propagated over a wireless channel with quantifiable properties e.g., rank, i.e., number of parallel streams that may be transmitted simultaneously, and the capacity for a given modulation order of the individual streams. Having received the signal, the channel rank and capacity is computed according to any known technique. Following, the method comprises analyzing the required complexity of the computed rank for a set of available receiver types, e.g., MRC, IRC, ML, and CWIC receivers. Some receiver types may be preferred for certain channel conditions—however these may also be computationally more complex for higher ranks and modulation orders. Hence one receiver type may be preferred for a lower rank and/or modulation order, whereas a simpler, and possibly less able receiver type may be preferred for a higher rank and/or modulation order. Based on the analysis, a preferred receiver type is selected to be used at reception, upon which the selected receiver type is used for processing received signals, e.g., demodulating and decoding data.

In one embodiment the received signal comprises, at least partly, pilot or reference signals with which channel properties, e.g., rank, capacity, etc., may be estimated.

In another embodiment, the analysis also comprises estimating the modulation order and coding rate for the estimated channel. These may also affect the complexity of different receiver types. For example the complexity of an ML receiver type is very much depending on the number of alternatives it has, which corresponds to the number of coded bits per symbol. Hence, in yet another embodiment, the method also comprises deriving parameters for a certain receiver type, in order for that receiver type to successfully provide an output within the given limitations that the transmission setup provides.

In one embodiment, á priori knowledge of the suitability, performance wise, of a certain receiver type may also be used when analyzing the receiver types.

In a further embodiment the result of the selection may also influence reported CSI, since for one receiver type, a certain MCS may be chosen that is not suitable for another receiver type. It is, e.g., well known in the art that the ML receiver type is more able with respect to correlated channels compared to, e.g., the MRC receiver type, and hence could be scheduled with a higher CQI value. Correspondingly, in yet another embodiment, the selected rank is adjusted depending on the selected receiver type.

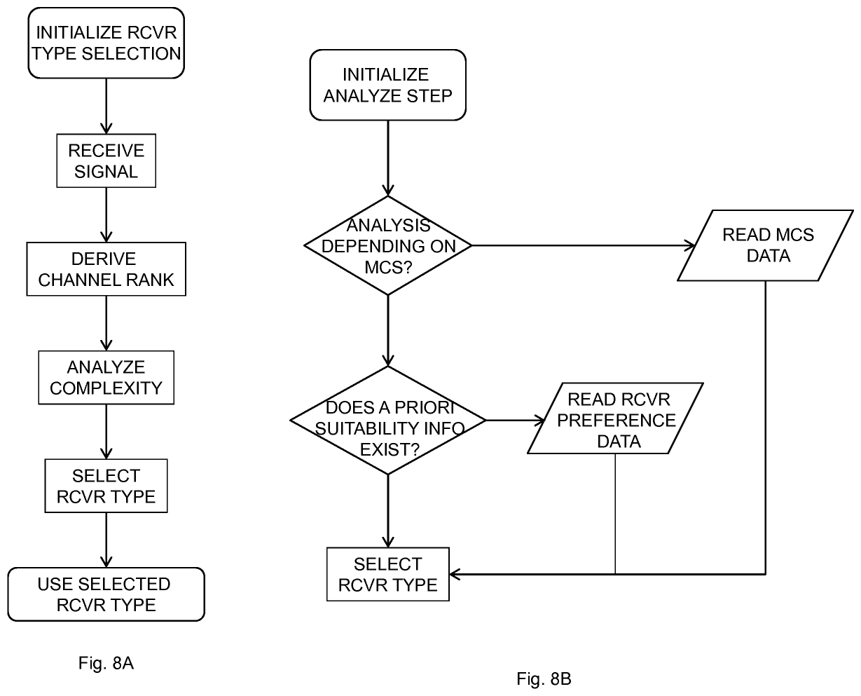

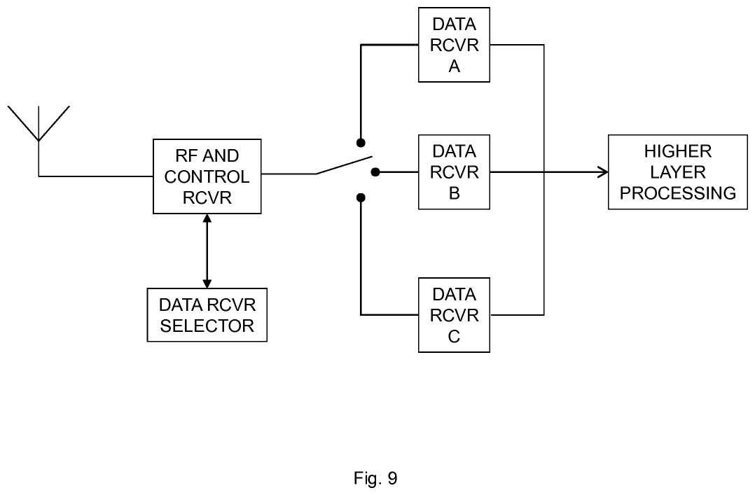

FIG. 8 shows exemplary flow charts for this rank-specific embodiment by describing the full receiver selection method in FIG. 8A, and the analysis part describing certain embodiments of the solution presented herein in FIG. 8B. Further, FIG. 9 shows an exemplary block diagram of this embodiment. As shown in FIG. 9, a selector switch is controlled by a Data Receiver Selector through an RF & Ctrl Receiver block, thus selecting which receiver type, e.g., which of Data Receiver A, Data Receiver B, and Data Receiver C, to use for data demodulation and decoding. Decoded data is then forwarded to Higher Layer Processing.

More particularly, this embodiment may be implemented as a method for selecting the receiver type to use for reception based on the channel rank. As shown in FIG. 8A, the method comprises receiving a signal, deriving properties from the received signal, analyzing the computational complexity required for different available receiver types, selecting at least one of the receiver types, and using the selected receiver type(s) to process received signals. In one embodiment the derived properties comprise the channel rank. In one embodiment, the derived properties comprise MCS. In one embodiment, the received signal comprises pilot signals. In one embodiment, analyzing the complexity also considers the modulation order and coding rate of the estimated channel. In one embodiment, analyzing the complexity also involves deriving receiver input parameters for a certain receiver type. In one embodiment, analyzing the complexity also involves á priori receiver preference based on the transmission setup and channel properties. In one embodiment, using the selected receiver type includes demodulating a received signal. In one embodiment, using the selected receiver type includes computing CSI data and reporting said CSI data to the transmitting node. In one embodiment, using the selected receiver type includes adjusting the rank to the selected receiver type such that the receiver is able to correctly decode the signal within a given error margin.

Additional embodiments consistent with the solution provided herein are described in greater detail in the attached appendix, which is entirely incorporated into, and is to be considered part of, the present disclosure.

Various elements disclosed herein are described as some kind of circuit, e.g., a memory, processing circuit, performance circuit, a selection circuit, a receiver configuration circuit, etc. Still other elements discussed herein, e.g., RF and control receiver, data receiver selector, data receivers, antennas, LNAs, FFTs, decoders, CPU cores, etc., are not explicitly described as circuits but are understood as representing circuits and/or hardware components. In any event, each of these circuits may be embodied in hardware and/or in software (including firmware, resident software, microcode, etc.) executed on a controller or processor, including an application specific integrated circuit (ASIC).

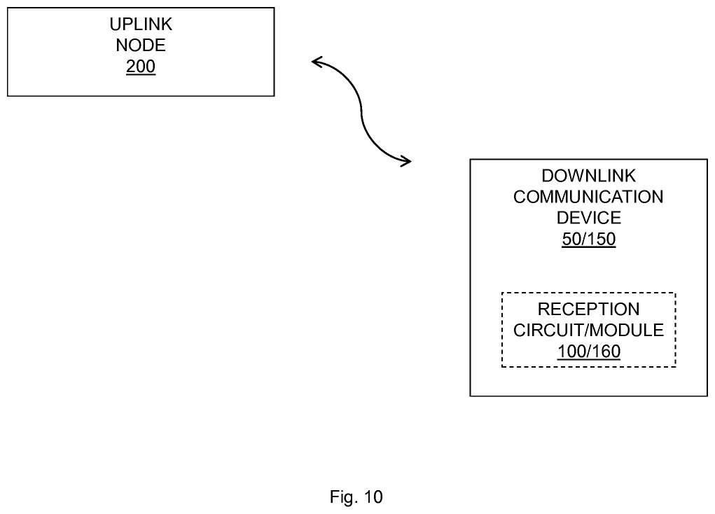

It will be appreciated that the solution presented herein may be implemented in any downlink wireless communication device, e.g., mobile telephones, sensors, tablets, personal computers, set-top boxes, cameras, etc. For example, as shown by the wireless network of FIG. 10, the reception circuit/module 100/160 may be implemented in a downlink communication device 50/150 in communication with an uplink node 200.

The solution presented herein may, of course, be carried out in other ways than those specifically set forth herein without departing from essential characteristics of the solution. The present embodiments are to be considered in all respects as illustrative and not restrictive, and all changes coming within the meaning and equivalency range of the appended embodiments are intended to be embraced therein.

1-38. (canceled)

39. A method of selecting one or more receiver configurations for a communication device comprising a plurality of circuits configurable into a plurality of different receiver configurations, the method comprising:
selecting a subset of the plurality of different receiver configurations responsive to an availability of one or more resources of the communication device;
determining a performance metric for each receiver configuration in the subset of the plurality of the different receiver configurations using a received signal and/or a signal strength determined for the corresponding receiver configuration and/or an interference level determined for the corresponding receiver configuration;
determining a scheduled amount of data to be received from the received signal;
selecting at least one of the receiver configurations in the subset responsive to the determined performance metrics and the schedule amount of data; and
configuring the communication device to use the at least one selected receiver configuration to process signals received by the communication device.

40. The method of claim 39 wherein the one or more resources comprise at least one of a number of clock cycles required to process the scheduled amount of data using the corresponding receiver configuration.

41. The method of claim 39 wherein the method further comprises selecting the subset of the plurality of different receiver configurations responsive to a complexity of each receiver configuration.

42. The method of claim 39 wherein determining the performance metric comprises determining a power consumption of the corresponding receiver configuration and/or a latency associated with the corresponding receiver configuration and/or a channel capacity and/or a throughput and/or a signal-to-interference and noise ratio for each receiver configuration in the subset using the received signal and/or the corresponding signal strength and/or the corresponding interference level.

43. The method of claim 39:
further comprising determining a channel rank responsive to the received signal;
wherein determining the performance metric comprises determining the performance metric for each receiver configuration in the subset using the channel rank.

44. The method of claim 39 wherein selecting a least one of the receiver configurations comprises selecting the receiver configuration having the best performance metric for the amount of scheduled data.

45. The method of claim 39 wherein selecting at least one of the receiver configurations further comprises selecting the receiver configuration responsive to at least one of a complexity of each receiver configuration for the amount of scheduled data and one or more resources available to the communication device for each receiver configuration for the amount of scheduled data.

46. The method of claim 39 wherein:
selecting at least one of the receiver configurations comprises selecting two or more of the receiver configurations in the subset responsive to the determined performance metrics and the scheduled amount of data; and
configuring the communication device to use the selected receiver configuration comprises configuring the communication device to use the two or more selected receiver configurations to process signals received by the communication device.

47. The method of claim 39 wherein the plurality of receiver configurations comprises any combination of:
a maximum ratio combining receiver configuration;
a two antenna interference rejection combining receiver configuration;
a four antenna interference rejection combining receiver configuration;
a single user multiple input, multiple output receiver configuration;
a two antenna network assisted interference cancellation and suppression receiver configuration;
a four antenna network assisted interference cancellation and suppression receiver configuration; or
a common reference signal interference cancellation receiver configuration.

48. The method of claim 39:
further comprising obtaining one or more transmission parameters;
wherein selecting at least one of the receiver configurations comprises selecting at least one of the receiver configurations in the subset responsive to the determined performance metrics, the scheduled amount of data, and the obtained one or more transmission parameters.

49. A communication device comprising:
a reception circuit comprising plurality of circuits configurable into a plurality of different receiver configurations; and
one or more processing circuits configured to:
select a subset of the plurality of different receiver configurations responsive to an availability of one or more resources of the communication device;
determine a performance metric for each receiver configuration in the subset of the plurality of the different receiver configurations using a received signal and/or a signal strength determined for the corresponding receiver configuration and/or an interference level determined for the corresponding receiver configuration;
determine a scheduled amount of data to be received from the received signal;
select at least one of the receiver configurations in the subset responsive to the determined performance metrics and the schedule amount of data; and
configure the communication device to use the at least one selected receiver configuration to process signals received by the communication device.

50. The communication device of claim 49 wherein the one or more resources comprise at least one of a number of clock cycles required to process the scheduled amount of data using the corresponding receiver configuration.

51. The communication device of claim 49 wherein the one or more processing circuits are further configured to select the subset of the plurality of different receiver configurations responsive to a complexity of each receiver configuration.

52. The communication device of claim 49 wherein the one or more processing circuits determine the performance metric by determining a power consumption of the corresponding receiver configuration and/or a latency associated with the corresponding receiver configuration and/or a channel capacity and/or a throughput and/or a signal-to-interference and noise ratio for each receiver configuration in the subset using the received signal and/or the corresponding signal strength and/or the corresponding interference level.

53. The communication device of claim 49 wherein:
the one or more processing circuits are further configured to determine a channel rank responsive to the received signal;
the one or more processing circuits determine the performance metric by determining the performance metric for each receiver configuration in the subset using the channel rank.

54. The communication device of claim 49 wherein the one or more processing circuits select a least one of the receiver configurations by selecting the receiver configuration having the best performance metric for the amount of scheduled data.

55. The communication device of claim 49 wherein the one or more processing circuits select at least one of the receiver configurations by selecting the receiver configuration responsive to at least one of a complexity of each receiver configuration for the amount of scheduled data and one or more resources available to the communication device for each receiver configuration for the amount of scheduled data.

56. The communication device of claim 49 wherein the one or more processing circuits:
select at least one of the receiver configurations by selecting two or more of the receiver configurations in the subset responsive to the determined performance metrics and the scheduled amount of data; and
configure the communication device to use the selected receiver configuration by configuring the communication device to use the two or more selected receiver configurations to process signals received by the communication device.

57. The communication device of claim 49 wherein the plurality of receiver configurations comprises any combination of:
a maximum ratio combining receiver configuration;
a two antenna interference rejection combining receiver configuration;
a four antenna interference rejection combining receiver configuration;
a single user multiple input, multiple output receiver configuration;
a two antenna network assisted interference cancellation and suppression receiver configuration;
a four antenna network assisted interference cancellation and suppression receiver configuration; or
a common reference signal interference cancellation receiver configuration.

58. The communication device of claim 49 wherein:
the one or more processing circuits are further configured to obtain one or more transmission parameters; and
wherein the one or more processing circuits select at least one of the receiver configurations by selecting at least one of the receiver configurations in the subset responsive to the determined performance metrics, the scheduled amount of data, and the obtained one or more transmission parameters.

59. A computer program product stored in a non-transitory computer readable medium for controlling a processor in a communication device comprising a plurality of circuits configurable into a plurality of different receiver configurations, the computer program product comprising software instructions which, when run on the processor, causes the processor to:
select a subset of the plurality of different receiver configurations responsive to an availability of one or more resources of the communication device;
determine a performance metric for each receiver configuration in the subset of the plurality of the different receiver configurations using a received signal and/or a signal strength determined for the corresponding receiver configuration and/or an interference level determined for the corresponding receiver configuration;
determine a scheduled amount of data to be received from the received signal;
select at least one of the receiver configurations in the subset responsive to the determined performance metrics and the schedule amount of data; and
configure the communication device to use the at least one selected receiver configuration to process signals received by the communication device.
